(19) United States
(12) Patent Application Publication
(10) Pub. No.: US 2017/0082751 A1
(43) Pub. Date: Mar. 23, 2017

(54) DEVICE FOR DETECTION OF OBSTACLES IN A HORIZONTAL PLANE AND DETECTION METHOD IMPLEMENTING SUCH A DEVICE

(71) Applicant: SOFTBANK ROBOTICS EUROPE, PARIS (FR)

(72) Inventors: Bruno MAISONNIER, PARIS (FR); Jörg ZIEGLER, PARIS (FR); Vincent CLERC, CLAMART (FR); Nicolas GARCIA, PARIS (FR)

(21) Appl. No.: 15/311,089

(22) PCT Filed: Jun. 2, 2015
(86) PCT No.: PCT/EP2015/062214

§ 371 Date: Nov. 14, 2016

(30) Foreign Application Priority Data
Jun. 5, 2014 (FR) 1455099

(51) Int. Cl. G01S 17/93; G01S 17/89; G01S 17/46; G01S 17/02

(52) U.S. Cl. CPC G01S 17/936; G01S 17/026; G01S 17/89; G01S 17/46

(57) ABSTRACT

An obstacle detection device fitted to a mobile vehicle able to move parallel to a reference plane, comprises: a first emitter referred to as a horizontal emitter of a first horizontal electromagnetic beam extending in a first virtual plane substantially parallel to the reference plane, a first image sensor able to cover a field intended to intersect with the first virtual plane to form a detection surface, an image analysis means able to determine the presence of an obstacle by detecting the presence of an image on the detection surface. A detection method employing the device is provided.

The invention relates to an obstacle detection device arranged on a mobile vehicle and applies in particular to the field of navigation. The invention also relates to an obstacle detection method employing such a device.

When a mobile vehicle such as a robot is moving around, it is desirable to avoid any collision between the mobile vehicle and an obstacle situated in the environment in which the mobile vehicle is moving, for example in order not to damage the mobile vehicle and/or the obstacle.

For any mobile vehicle and, therefore, also for a robot able to move, it is very important to take into account the safety of the mobile vehicle and of the elements in its environment. The safety of the vehicle and of the elements in its environment notably includes detecting obstacles in the environment and avoiding collisions with these obstacles. There are various techniques for avoiding collisions. Most of these techniques involve significant implementation costs and require significant computation power in order, for example, to determine the position of the robot in a certain frame of reference. Other existing techniques are very expensive and are therefore not suited to use in a robot.

The invention seeks to alleviate all or some of the problems mentioned hereinabove by proposing a device for detecting obstacles situated in the environment of a mobile vehicle and a method employing such a device.

To this end, one subject of the invention is an obstacle detection device intended to be fitted to a mobile vehicle able to move parallel to a reference plane, characterized in that it comprises:
a first emitter referred to as a horizontal emitter of a first horizontal electromagnetic beam extending in a first virtual plane substantially parallel to the reference plane,
a first image sensor able to cover a field intended to intersect with the first virtual plane to form a detection surface,
an image analysis means able to determine the presence of an obstacle by detecting the presence of an image on the detection surface.

According to one embodiment, the vehicle has a favored direction of travel in a first direction along an axis X and the device further comprises a first emitter referred to as an oblique emitter of a first oblique beam extending in a first oblique virtual plane in the first direction along the axis X and secant with the reference plane, and a second emitter referred to as an oblique emitter of a second oblique beam extending in a second oblique virtual plane in the first direction along the axis X and secant with the reference plane. The device also comprises a first image sensor able to produce an image around the intersection of the first and second oblique virtual planes with the reference plane.

According to one embodiment of the invention, the device comprises a first emitter referred to as a horizontal emitter of a first horizontal electromagnetic beam extending in a first virtual plane substantially parallel to the reference plane and the first image sensor is able to produce an image of the intersection of the first virtual plane and of the obstacle.

According to another embodiment, the first virtual plane forms an angular sector around the axis X, and the device further comprises a second emitter referred to as a horizontal emitter of a second horizontal beam extending in a second virtual plane in a first direction, forming an angular sector about an axis Y perpendicular to the axis X and substantially parallel to the reference plane. The device comprises a second image sensor able to produce an image of the intersection of the second virtual plane and of the obstacle. The device comprises a third emitter referred to as a horizontal emitter of a third horizontal beam extending in a third virtual plane in a second direction, the opposite of the first direction, forming an angular sector about the axis Y and substantially parallel to the reference plane, and a third image sensor able to produce an image of the intersection of the third virtual plane and of the obstacle.

Advantageously, the angular sector formed by the first horizontal beam is spaced away from the angular sectors formed by the second and third horizontal beams by a predefined angle.

Advantageously, the angular sector is 120°.

According to another embodiment, the device further comprises positioning means for positioning a virtual plane referred to as a horizontal plane, which means are intended to position said virtual plane referred to as a horizontal plane in such a way that it does not intersect the reference plane.

The positioning means may consist of a control loop able to determine an angular position of the virtual plane referred to as a horizontal plane with respect to the reference plane and to transmit a new angular position to the emitter referred to as a horizontal emitter that forms the virtual plane referred to as a horizontal plane.

The positioning means may also consist of a positive angle between the virtual plane referred to as a horizontal plane and the reference plane.

According to another embodiment, the device further comprises an emitter referred to as a shovel emitter of a shovel beam extending in a virtual plane configured to intersect with the reference plane along a straight line perpendicular to the axis X, and the first image sensor is able to produce an image of the straight line.

Advantageously, the beam or beams are laser beams.

Advantageously, the device comprises control means configured to selectively deactivate emitters and sensors according to the direction of travel of the vehicle.

Advantageously, the device further comprises a processing circuit configured to sequence the emissions of beams by the emitters and to synchronize the emissions of beams with the capturing of images by the sensors.

Another subject of the invention is a vehicle employing such a device.

Another subject of the invention is an obstacle detection method employing such a device, characterized in that it comprises the following steps:
emission of a beam able to form a virtual plane that may intersect with the obstacle,
image capture and production of an image of the intersection of the virtual plane and of the obstacle,
image analysis and determination of the obstacle.

According to one embodiment, the method according to the invention may also involve the following steps:
memory storage of a first image of the intersection of the virtual plane formed by the shovel beam with the reference plane,
memory storage of a second image of the intersection of the virtual plane formed by the shovel beam with the obstacle,
comparison of the first and second images so as to define the location of the obstacle.

The mobile vehicle is, for example, a robot. This robot may have wheels to allow it to move around on a reference plane. The invention also applies to a humanoid robot moving on legs.

Alternatively, the mobile vehicle may be any type of vehicle moving around parallel to a reference plane, either in contact with the reference plane via wheels, or on air cushions.

Another subject of the invention is a humanoid robot comprising a detection device according to the invention.

A humanoid robot means a robot exhibiting similarities with the human body. This may be the upper part of the body, or just an articulated arm ending in a gripper that can be likened to a human hand. In the present invention, the upper part of the robot body is similar to that of a human torso. A detection device according to the invention makes it possible to determine obstacles in the environment of the robot.

The invention will be better understood and further advantages will become apparent on reading the detailed description of one embodiment given by way of example, which description is illustrated by the attached drawing in which:

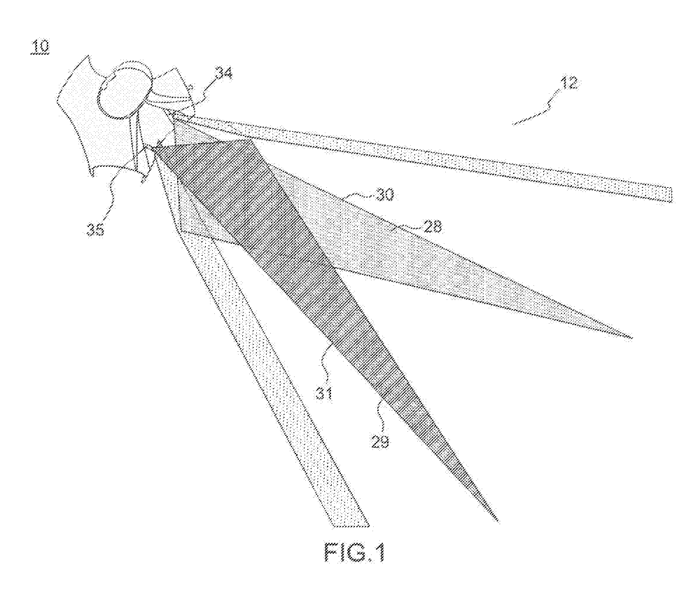

FIG. 1 depicts virtual planes formed by two beams,

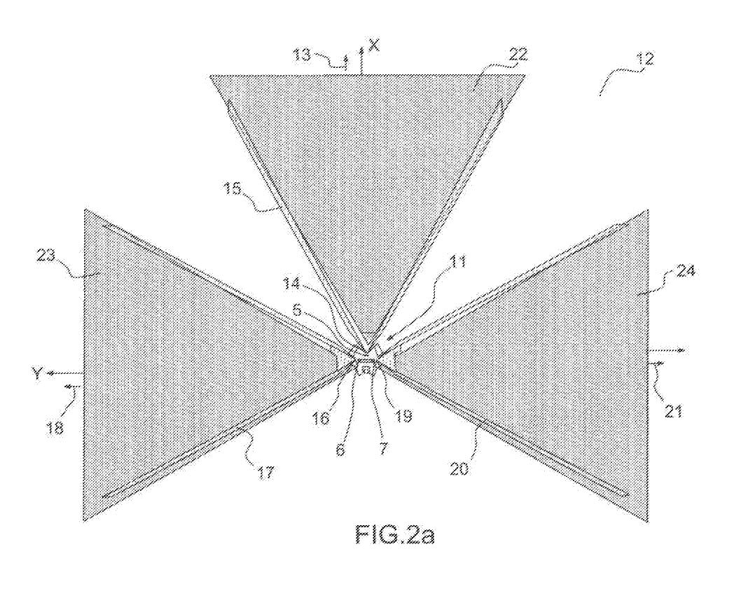

FIG. 2a depicts a plan view of a device according to the invention showing virtual planes of the beams parallel to the reference plane,

FIG. 2b depicts a view in cross section of a device according to the invention showing a virtual plane of a beam substantially parallel to the reference plane,

FIG. 2c depicts a control loop allowing an angular position of a virtual plane to be adjusted with respect to the reference plane,

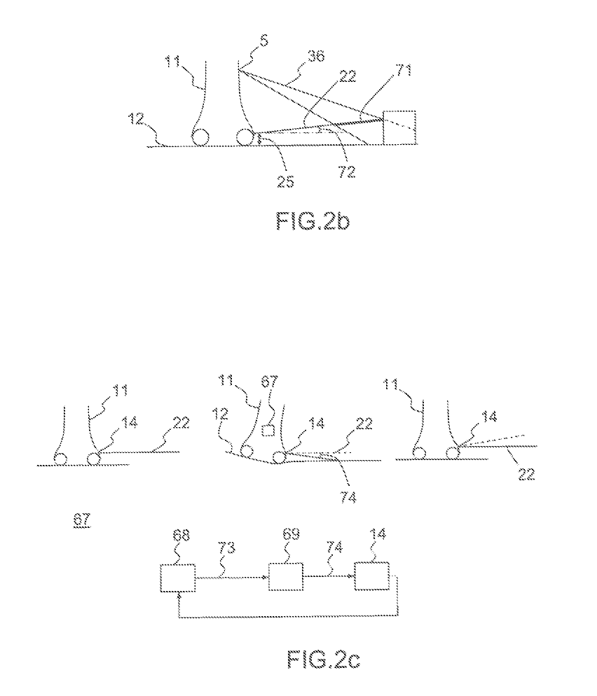

FIG. 3 depicts a virtual plane formed by a beam and virtual planes formed by two beams,

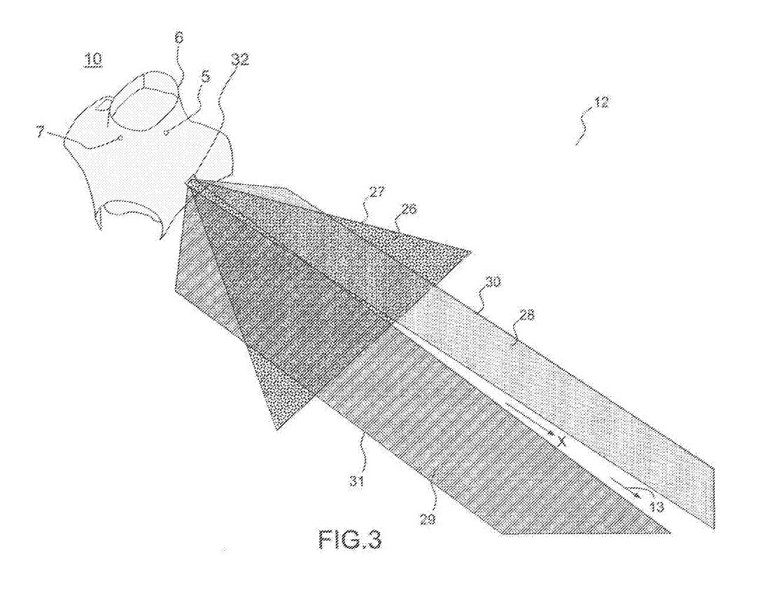

FIGS. 4a, 4b, 4c depict an intersection of a virtual plane with an obstacle according to the invention,

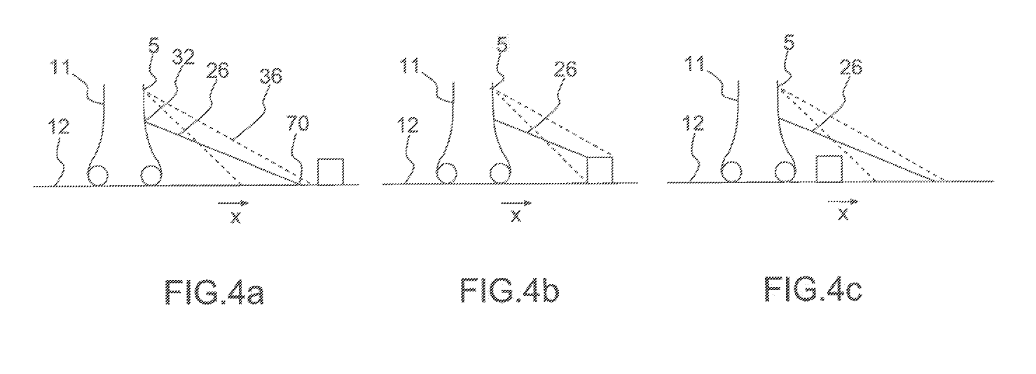

FIG. 5 depicts virtual planes formed by beams and a field covered by an image capture apparatus,

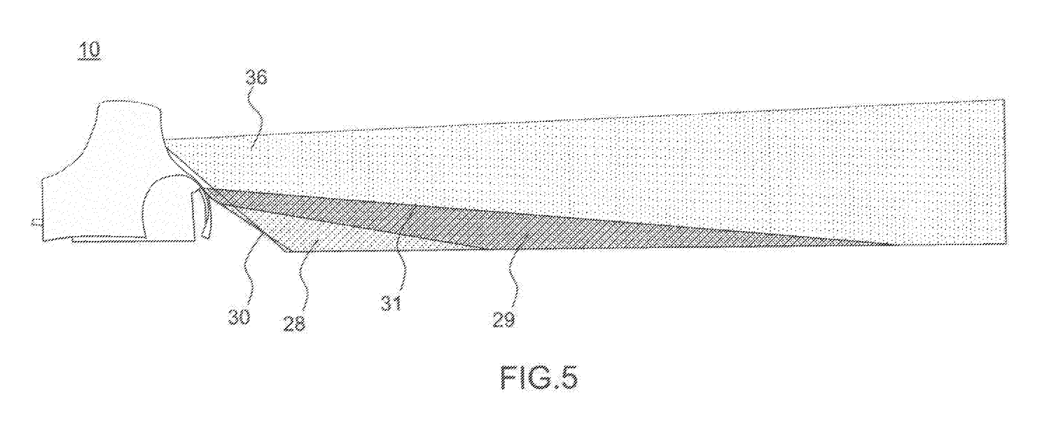

FIG. 6 depicts an emitter of a beam able to form a virtual plane,

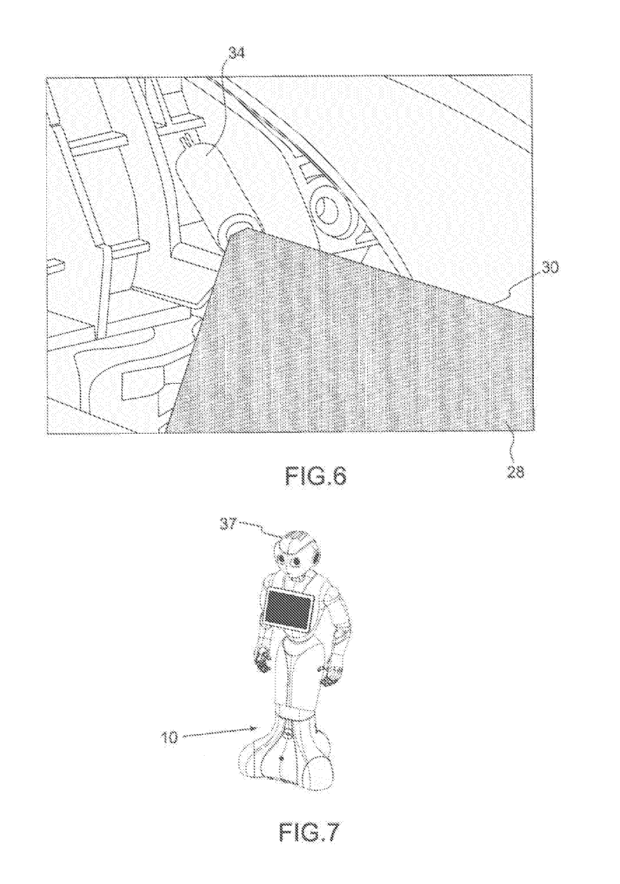

FIG. 7 depicts a humanoid robot employing an obstacle detection device according to the invention,

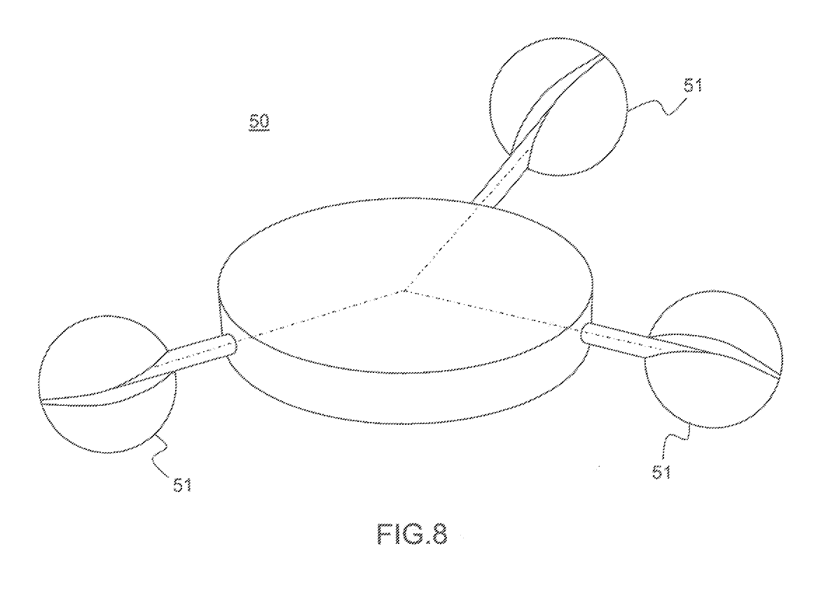

FIG. 8 depicts an example of a base comprising wheels for a humanoid robot employing an obstacle detection device according to the invention,

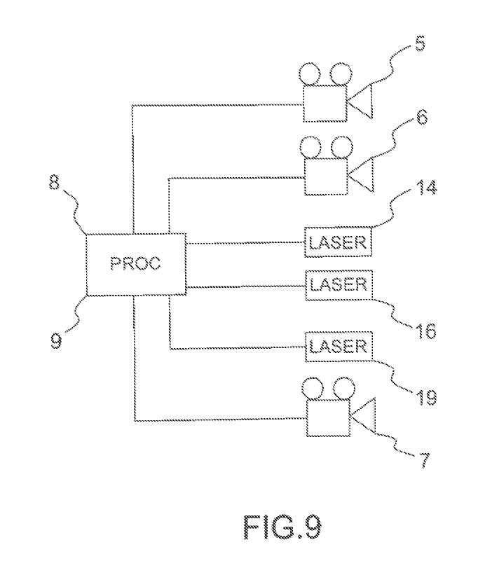

FIG. 9 schematically depicts a processor that performs the functions of processing and synchronizing the emissions of beams and image capturing,

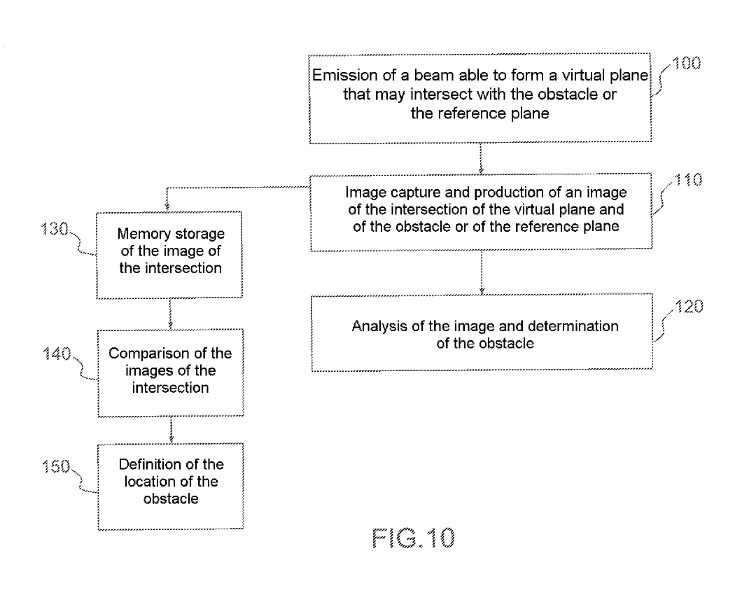

FIG. 10 schematically illustrates the steps in an obstacle detection method according to the invention,

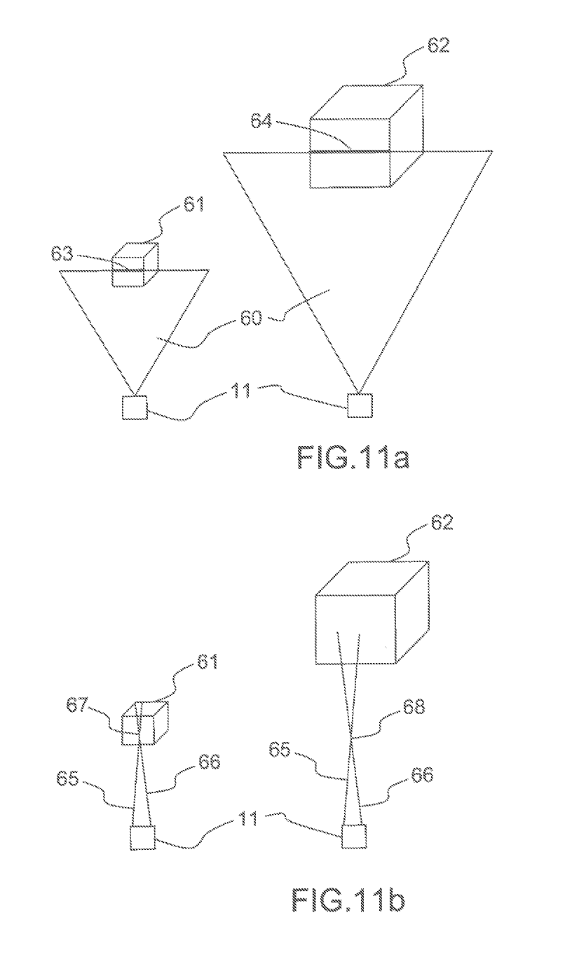

FIGS. 11a and 11b depict two obstacle detection configurations,

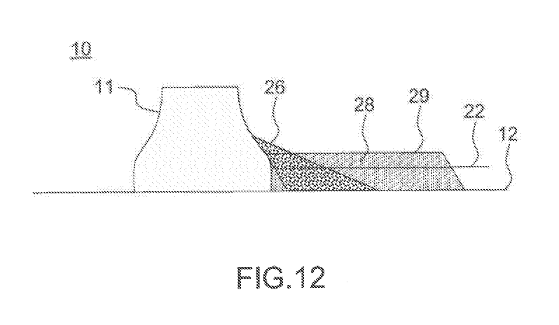

FIG. 12 schematically illustrates a side view of a device according to the invention showing horizontal, oblique and shovel virtual planes.

For the sake of clarity, the same elements will bear the same references in the various figures.

In the description, the invention is described with the example of an implementation on a robot and, more particularly, on a robot moving around by means of wheels. However, the invention applies to any mobile vehicle. A mobile vehicle 11 has a favored direction of travel in a first direction along an axis X.

FIG. 1 depicts a view of the device 10 according to the invention. The obstacle detection device 10 intended to be fitted to the mobile vehicle 11 able to move parallel to a reference plane 12 comprises at least two emitters 34, 35 of electromagnetic beams able to form two virtual planes in two different directions which may intersect with a potential obstacle, at least one image sensor 5 (not depicted in FIG. 1) able to produce an image of the intersection of the virtual planes and of the obstacle, an image analysis means 66 (not depicted in FIG. 1) able to determine the obstacle, configured to compare the image with a reference image. In other words, the virtual planes formed intersect the reference plane 12 and thus form a straight line. If an obstacle is present, the line is then deformed, and it is the deformation of the line that reveals the presence of an obstacle. Thus, a virtual plane is projected, the image obtained is studied and obstacle detection is obtained via the deformation of the line of intersection between the virtual plane and the obstacle.

FIG. 1 depicts virtual planes 28, 29 formed by emitters referred to as oblique emitters 34, 35. The device 10 comprises a first emitter referred to as an oblique emitter 34 of a first oblique beam 30 extending in a first oblique virtual plane 28 in the first direction along the axis X and secant with the reference plane 12. The device 10 comprises a second emitter referred to as an oblique emitter 35 of a second oblique beam 31 extending in a second oblique virtual plane 29 in the first direction along the axis X and secant with the reference plane 12. The first image sensor 5 is able to produce an image around the intersection of the oblique virtual planes 28, 29 with the reference plane 12.

FIG. 2a is a plan view of a device according to the invention showing virtual planes of the beams parallel to the reference plane 12.

The device 10 comprises a first emitter referred to as a horizontal emitter 14 of a first horizontal beam 15 extending in a first virtual plane 22 substantially parallel to the reference plane 12 and the first image sensor 5 able to produce an image of the intersection of the first virtual plane 22 and of the obstacle.

Because the mobile vehicle 11 has a favored direction of travel in the first direction along the axis X, the first virtual plane 22 forms an angular sector about the axis X, and the device 10 further comprises a second emitter referred to as a horizontal emitter 16 of a second horizontal beam 17 extending in a second virtual plane 23 in a first direction, forming an angular sector about an axis Y perpendicular to the axis X and substantially parallel to the reference plane 12. The device 10 comprises a second image sensor 6 able to produce an image of the intersection of the second virtual plane 23 and of the obstacle. The device comprises a third emitter referred to as a horizontal emitter 19 of a third horizontal beam 20 extending in a third virtual plane 24 in a second direction that is the opposite of the first direction, forming an angular sector about the axis Y and substantially parallel to the reference plane 12. The device 10 comprises a third image sensor 7 able to produce an image of the intersection of the third virtual plane 23 and of the obstacle.

Advantageously, the angular sector 22 formed by the first horizontal beam 15 is spaced away from the angular sectors 23, 24 formed by the second and third horizontal beams 17, 20 by a predefined angle.

The angular sector may be 60° and the predefined angle 30°. It is also possible to have an angular sector of 90°. Advantageously, the angular sector is 120° and the predefined angle is 0°. This configuration provides complete coverage of the environment around the mobile vehicle 11.

The first, second and third emitters referred to as horizontal emitters 14, 16, 19 are positioned on the mobile vehicle 11 at a certain height 25 from the reference plane 12 (visible in FIG. 2b). The height 25 may for example be 15 cm or 10 cm. In order to detect small obstacles, the height 25 may be 5 or 3 cm. The virtual planes 22, 23, 24 formed respectively by the emitters 14, 16, 19 may intersect with an obstacle situated at a height greater than the height 25, or with an obstacle, part of which lies at the level of the virtual planes 22, 23 or 24. The emitters 14, 16, 19 allow obstacle detection that may be qualified as panoramic detection.

The image sensor 5 may also be a “wide angle” image sensor able on its own to capture images of the three virtual planes 22, 23 and 24.

FIG. 2b depicts a view in cross section of a device according to the invention showing the virtual plane 22 of the beam 15 substantially parallel to the reference plane 12. It is the virtual plane 22 that will be described here, but all of this description is equally valid for the virtual planes 23 and 24.

Advantageously, the detection device according to the invention comprises means 67 so that the virtual plane 22 is always above the reference plane 12 in a field 36 covered by the image sensor 5.

The means 67 whereby the virtual plane 22 is always above the reference plane 12 in a field 36 may consist of a control loop that allows the emitter 14 of the beam 15 to be oriented in such a way as to orient the virtual plane 22 according to its orientation when the mobile vehicle 11 is in motion. Thus, if the mobile vehicle 11 is moving over a reference plane that has unevennesses, as depicted in FIG. 2c, the virtual plane 22 may be forced to intersect the reference plane 12. A gyroscope 68 may capture an angular position 73 of the virtual plane 22 with respect to the reference plane 12. An analysis means 69 in the control loop picks up this information, transmits a new angular position 74 to the emitter 14 which is then oriented in such a way as to position the virtual plane 22 above the reference plane 12. When the mobile vehicle 11 is once again moving around over a completely flat surface, the analysis means 69 transmits to the emitter 14 a new angular position such that the virtual plane 22 is positioned back substantially parallel to the reference plane 12.

According to another configuration, the positioning means consist of an angle 72 between the virtual plane referred to as a horizontal plane 22 and the reference plane 12. The virtual plane 22 may therefore be oriented slightly upward. In other words, it forms the angle 72, which is a positive angle, with the reference plane 12. Thus, the virtual plane 22 never intersects the reference plane 12 even when the mobile vehicle 11 is in motion. The image sensor 5 is able to produce an image of the intersection of the virtual plane 22 and of a potential obstacle.

It is also possible to define a detection surface 71 which corresponds to the intersection of the virtual plane 22 and of the cone formed by the field 36 covered by the image sensor 5. The virtual plane 22 alone may intersect with a potential obstacle having approximately a height greater than or equal to the height 25 and which may be situated at infinity. Because of the positive angle 72 and the field 36 of the image sensor 5, the detection surface 71 is situated near the mobile vehicle 11. Detecting a potential obstacle therefore amounts to detecting the appearance of an image at the detection surface 71.

The oblique beams 30, 31 may intersect with small obstacles, holes or larger obstacles with which the horizontal beams 15, 17, 20 may possibly not have been able to intersect.

FIG. 3 depicts a virtual plane 26 formed by a shovel beam 27 emitted by an emitter referred to as a shovel emitter 32. The device 10 comprises the emitter referred to as a shovel emitter 32 of a shovel beam 27 extending in a virtual plane 26 configured to intersect with the reference plane 12 along a straight line perpendicular to the axis X. The first image sensor 5 is able to produce an image of the straight line resulting from the intersection of the virtual plane 26 and of the reference plane 12. The virtual plane 26 formed by the emitter 32 may intersect with an obstacle situated at a height corresponding to the distance 33 between the virtual plane 26 and the reference plane 12. This may be a large-sized or small-sized obstacle placed on the reference plane 12. It finds a particularly advantageous application for obstacles the height of which is less than the height 25 separating the reference plane 12 from a horizontal virtual plane. A hole or a door stop may notably be mentioned by way of examples of obstacles.

FIGS. 4a, 4b and 4c depict an intersection of the virtual plane 26 with an obstacle according to the invention. The vehicle 11 is able to move parallel to the reference plane 12. The shovel emitter 32 of the shovel beam 27 extends in the virtual plane 26. The virtual plane 26 is configured to intersect with the reference plane 12 along a straight line 70 perpendicular to the axis X, as depicted in FIG. 4a.

In other words, the virtual plane 26 formed by the shovel beam 27 allows a scan to be made of the reference plane 12. The image sensor 5 is able to produce an image of the straight line 70. An image analysis means is able to determine the presence of the obstacle, the analysis means being configured to compare the image from the sensor 5 with a reference image. It is therefore a matter of projecting a line onto the reference plane 12 in the field 36 of the image sensor 5. The use of the virtual plane 26 instantaneously makes it possible to detect, if an obstacle is present, a deformation of the line 70. Moreover, it is possible to store in memory everything that lies in the volume between the virtual plane 26 and the reference plane 12. Thus, in a use coupled with time (namely with successive positions of the mobile vehicle 11) and with memory storage, the moment in time at which there is an obstacle in the environment of the mobile vehicle 11 is known. In other words, it is possible to store in memory, at different moments in time, a first image and a second image of the intersection of the virtual plane 26 formed by the shovel beam 27 with the reference plane 12. The first and second images are compared in order to define the location of the obstacle. The obstacle may be located in a fixed frame of reference or in a frame of reference connected with the mobile vehicle 11. This obstacle detection and location may be performed when the mobile vehicle is moving in the first direction along the axis X, but also in the opposite direction from the first direction (which means to say when moving forward or backward). It is then possible to slow the mobile vehicle 11 and stop it before it collides with the obstacle or to make it divert its path. Finally, in the extreme case of the line 70 disappearing, that means that the mobile vehicle 1 is near a cliff or a step of a staircase, because the image sensor 5 is then no longer able to produce an image of the straight line 70 which is then at a lower level than the reference plane 12. Conversely, as soon as the image sensor 5 is able to produce an image, which means to say a break in the virtual plane 26, that means either that the mobile vehicle 11 can move forward and back on the reference plane 12 without the risk of falling into a void (cliff, staircase, etc.), or that the mobile vehicle 11 is in the presence of an obstacle nearby.

It should be noted that the shovel beam can be used alone, independently of the other oblique and horizontal beams. Likewise it is entirely possible to use only the oblique beams. Finally, it is possible to use several beams together, for example a shovel beam with a horizontal beam, a shovel beam with an oblique beam, an oblique beam with a horizontal beam or another other combination of two or more beams.

Thus, the six beams 15, 17, 20, 27, 30, 31 allow the device 10 to form an intersection with virtual planes and any obstacle situated in a nearby environment.

FIG. 5 depicts a side view of the virtual planes 28, 29 formed by the oblique beams 30, 31 and the field 36 covered by the image sensor 5. The virtual planes 28, 29 formed respectively by the beams 30, 31 may intersect with an obstacle. The image sensor 5 may then produce an image of the intersection of the virtual plane or planes 28, 29 with the obstacle. An image analysis means (not depicted in the figure) is then able to determine the obstacle, configured to compare the image obtained with a reference image.

More specifically, the virtual planes 26, 28, 29 intersect the reference plane 12 (which in most cases corresponds to the ground on which the mobile vehicle 11 is moving) and thus form a straight line. If an obstacle is present, the line thus formed is perturbed, and it is the perturbation of the line that reveals the presence of an obstacle.

It is important to note that the image sensor 5, for example a camera, is advantageously synchronized with the beam emitters, allowing the beam emitters to be active only during the exposure time of the image sensor 5. It is also necessary to take into account the offset between the moment in time the decision to expose is taken (for example on the part of a processor PROC arranged in the mobile vehicle 11) and the moment in time at which the image sensor actually does capture the image.

It is also particularly advantageous to sequence all the beam-emitting apparatus with one another by using a common pulse. This synchronization makes it possible to avoid interference between various beams, which would supply incorrect information to the image capture and image analysis apparatus.

In order to do this, as depicted in FIG. 9, the device 10 comprises control means 8 configured to selectively deactivate emitters and sensors according to the direction of travel of the vehicle 11. That makes it possible to reduce the energy consumption of the device 10.

The device 10 further comprises a processing circuit 9 configured to sequence the emissions of beams by the emitters and to synchronize the emissions of beams with the capturing of images by the sensors. Thus, the beams are emitted one after the other or simultaneously depending on the configuration the mobile vehicle 11 is in. And, on each emission of a beam, the associated image sensor captures an image. For example, in order to obtain a panoramic view of the environment of the mobile vehicle 11, the three horizontal beams 15, 17, 20 are emitted simultaneously and the three image sensors 5, 6, 7 each produce an image. If a view of the favored direction of travel along the axis X is desired, the first horizontal beam may be emitted before the beam referred to as the shovel beam, and the corresponding image sensor 5 is activated in sequence, capturing a first image at the same time as the horizontal beam is emitted, then a second image at the same time as the beam referred to as the shovel beam is emitted.

FIG. 6 depicts the emitter 34 emitting the beam 30 able to form the virtual plane 28. Advantageously, the beam emitters are fixed on the mobile vehicle 11 in order to avoid having moving parts in and/or on the mobile vehicle 11. The attachment of the beam emitters thus offers good robustness while the mobile vehicle 11 is being transported and against vibrations of a moving part.

Advantageously, the beam or beams are laser beams.

The device 10 according to the invention may also have an exposure control means available and this may consist of a contrast-enhancing algorithm enhancing the contrast between the light of the emitted beam and the environment. Such a control means may notably allow the device 10 to consider only a zone referred to as a safety zone in a close environment of the mobile vehicle 11. The precision with which the obstacle is determined is thus improved.

Because a component cannot be produced with a rigorously exact geometry and dimensions, and in order for the component to be able to perform its functions in a mechanism, tolerances (dimensional and geometric) are defined. These tolerances may have an impact on the precision of the measurements. The device 10 may have available to it a mechanism for calibrating the angle of inclination of the image sensor 5 and the angle of inclination of the emitters 14, 16, 19 of the beams 15, 17, 20. Such a calibration mechanism is generally employed in a known environment and ensures good precision of the measurements and therefore of the determination of the obstacle.

FIG. 7 depicts a humanoid robot 37 employing the obstacle detection device 10 according to the invention.

FIG. 8 depicts one example of a base 50 comprising wheels 51 for a humanoid robot employing the obstacle detection device according to the invention.

FIG. 9 schematically depicts a processor PROC performing the functions of processing and synchronizing the emissions of beams and image capture.

FIG. 10 schematically illustrates the steps in an obstacle detection method according to the invention. The detection method employs the detection device as described hereinabove. It comprises the following steps:
emission of a beam able to form a virtual plane that may intersect with the obstacle (step 100),
image capture and production of an image of the intersection of the virtual plane and of the obstacle (step 110),
image analysis and determination of the obstacle (step 120).

The method further comprises the following steps:
memory storage of a first image of the intersection of the virtual plane (26) formed by the shovel beam (27) with the reference plane (12) (step 130),
memory storage of a second image of the intersection of the virtual plane (26) formed by the shovel beam (27) with the obstacle (step 130),
comparison of the first and second images (step 140) so as to define the location of the obstacle (step 150).

FIGS. 11a and 11b depict two obstacle detection configurations. In FIG. 11a, a single virtual plane 60 intersects with an obstacle. In FIG. 11b, two virtual planes 65, 66 intersect with one another and with an obstacle with a detection device according to the invention. Present in the two configurations are two similar obstacles 61, 62 (two cubes in the example depicted): one of them, 61, is small and close to the mobile vehicle 11, the second one, 62, is large and further away from the mobile vehicle 11. In FIG. 11a, the virtual plane 60 intersects with the small cube 61. Likewise, the virtual plane 60 intersects with the large cube 62. An intersection 63 between the virtual plane 60 and the small cube 61 and an intersection 64 between the virtual plane 60 and the large cube 62 each form a line. Nevertheless, because of the difference in size between the two cubes 61, 62 and the greater separation from the mobile vehicle 11 of the large cube 62 compared with the small cube 61, the two lines of intersection 63, 64 are perceived as identical by the image sensor. In FIG. 11b, two virtual planes 65, 66 intersect with one another and with, on the one hand, the small cube 61 close to the mobile vehicle 11, to form a line of intersection 67. The two virtual planes 65, 66 also intersect with one another but not with the large cube 62, which is too far away for the intersection 68 between the two virtual planes 65, 66 to coincide with an intersection with the large cube 62. Thus, obstacle detection with two virtual planes in different directions and intersecting with one another allows more precise determination of an obstacle.

After the obstacle has been determined (step 120) it is possible for the vehicle 11 to perform a further action. Mention may be made by way of example of a navigation action with a change in path or a stoppage. The device 10 according to the invention may also have a library of reference images available to it. These reference images correspond to predefined images allowing, in addition to obstacle detection, obstacle recognition by comparing the image produced by the image sensor 5 with the reference images. The image analysis thus performed may notably allow the mobile vehicle 11 to recognize its recharging base and head in that direction in order to recharge its battery.

FIG. 12 schematically illustrates a side view of the device 10 according to the invention showing the horizontal virtual planes (only the plane 22 is depicted), the oblique virtual planes 28, 29 and the shovel virtual plane 26.

Advantageously, after image capture and obstacle determination (step 110), the location of the obstacle is communicated in Cartesian coordinates in the frame of reference containing the axes X and Y. That allows the information transmitted to be compressed.

Finally, it is possible to reduce the resolution of the images captured by the image sensor in order to reduce the cost of the device 10. It is also possible to manage all the beam emitters and image sensors using one single processor, again with a view to reducing the costs of the device 10.

1. An obstacle detection device fitted to a mobile vehicle having a favored direction of travel in a first direction along an axis X, parallel to a reference plane comprising:
a first emitter referred to as a horizontal emitter of a first horizontal electromagnetic beam extending in a first virtual plane substantially parallel to the reference plane,
a first image sensor able to cover a field intended to intersect with the first virtual plane to form a detection surface,
an image analysis means able to determine the presence of an obstacle by detecting the presence of an image on the detection surface,
wherein the first virtual plane forms an angular sector around the axis X, and wherein the device further comprises:
a second emitter referred to as a horizontal emitter of a second horizontal beam extending in a second virtual plane in a first direction, forming an angular sector about an axis Y perpendicular to the axis X and substantially parallel to the reference plane,
a second image sensor able to produce an image of the intersection of the second virtual plane and of the obstacle,
a third emitter referred to as a horizontal emitter of a third horizontal beam extending in a third virtual plane in a second direction, the opposite of the first direction, forming an angular sector about the axis Y and substantially parallel to the reference plane,
a third image sensor able to produce an image of the intersection of the third virtual plane and of the obstacle.

2. The device as claimed in claim 1, wherein the vehicle further comprises:
a first emitter referred to as an oblique emitter of a first oblique beam extending in a first oblique virtual plane in the first direction along the axis X and secant with the reference plane,
a second emitter referred to as an oblique emitter of a second oblique beam extending in a second oblique virtual plane in the first direction along the axis X and secant with the reference plane,
and wherein the first image sensor is able to produce an image around the intersection of the first and second oblique virtual planes with the reference plane.

3. The device as claimed in claim 1, wherein the angular sector formed by the first horizontal beam is spaced away from the angular sectors formed by the second and third horizontal beams by a predefined angle.

4. The device as claimed in claim 3, wherein the angular sector is 120°.

5. The device as claimed in claim 1, further comprising positioning means for positioning a virtual plane referred to as a horizontal plane which means are intended to position said virtual plane referred to as a horizontal plane in such a way that it does not intersect the reference plane.

6. The device as claimed in claim 5, wherein the positioning means consist of a control loop able to determine an angular position of the virtual plane referred to as a horizontal plane with respect to the reference plane and to transmit a new angular position to the emitter referred to as a horizontal emitter that forms the virtual plane referred to as a horizontal plane.

7. The positioning device as claimed in claim 5, wherein the positioning means consist of an orientation of the emitter of the beam so as to orient the virtual plane referred to as a horizontal plane in such a way as to form a positive angle between the virtual plane referred to as a horizontal plane and the reference plane.

8. The device as claimed in claim 1, the vehicle having a favored direction of travel in a first direction along an axis X, further comprising:
an emitter referred to as a shovel emitter of a shovel beam extending in a virtual plane configured to intersect with the reference plane along a straight line perpendicular to the axis X,
an image analysis means,
wherein the first image sensor is able to produce an image of the straight line, and wherein the image analysis means is able to determine the presence of an obstacle by detecting a deformation of the straight line.

9. The device as claimed in claim 1, comprising control means configured to selectively deactivate emitters and sensors according to the direction of travel of the vehicle.

10. The device as claimed in claim 1, further comprising a processing circuit configured to sequence the emissions of beams by the emitters and to synchronize the emissions of beams with the capturing of images by the sensors.

11. The device as claimed in claim 1, wherein the beam or beams are laser beams.

12. A vehicle comprising an obstacle detection device as claimed in claim 1.

13. An obstacle detection method employing a device as claimed in claim 1, comprising the following steps:
emission of a beam able to form a virtual plane that may intersect with the obstacle,
image capture and production of an image of the intersection of the virtual plane and of the obstacle,
image analysis and determination of the obstacle.

14. The detection method as claimed in claim 13, further comprising the following steps:
memory storage of a first image of the intersection of the virtual plane formed by the shovel beam with the reference plane,
memory storage of a second image of the intersection of the virtual plane formed by the shovel beam with the obstacle,
comparison of the first and second images so as to define the location of the obstacle.
